(19) United States
(12) Patent Application Publication
(10) Pub. No.: US 2010/0242020 A1
(43) Pub. Date: Sep. 23, 2010

(54) SCA-BASED SYSTEM, AND FILE PARSING METHOD AND APPLICATION GENERATION METHOD THEREOF

(76) Inventors: Eun Seon Cho, Daejeon (KR); Nam Hoon Park, Daejeon (KR)

Correspondence Address: LAHIVE & COCKFIELD, LLP;FLOOR 30, SUITE 3000, ONE POST OFFICE SQUARE, BOSTON, MA, 02109, US

(21) Appl. No.: 12/681,275

(22) PCT Filed: May 8, 2008
(86) PCT No.: PCT/KR08/02601

§ 371 Date: Apr. 1, 2010

(30) Foreign Application Priority Data
Oct. 1, 2007 (KR) 10-2007-0098704

(51) Int. Cl. G06F 9/44; G06F 17/30

(52) U.S. Cl. 717/120; 707/822; 707/E17.01

(57) ABSTRACT

The present invention relates to a software communications architecture (SCA)-based system, and a file parsing method and an application generation method thereof. In the present invention, the SCA-based system integrates parsers related to application driving into one parser to generate one integration parser, and implements a parser manager that executes an integration parser function by a common object request broker architecture (CORBA) component. Therefore, when the other manager components need information of descriptor files related to application driving, the other manager components request it from the parser manager of the corresponding information without generating a new parser, and the parser manager provides the corresponding information to the other manager components.

### TECHNICAL FIELD

The present invention relates to an SCA-based system, and a file parsing method and an application generation method thereof.

The present invention was supported by the IT R&D program of MIC/IITA [2006-S-012-02, Development of Middleware Platform Technology based on the SDR Mobile Station].

### BACKGROUND ART

The software communications architecture (SCA) standard is a communication software structure that was suggested by the Joint Tactical Radio System (JTRS) Joint Program Office (JPO) that was established to develop a future communication system using a technology that is currently under development, for the purpose of improving interoperability between communication systems and reducing development and disposition costs. The SCA standard was established to secure portability and configurability of software and hardware and interoperability between products developed using the SCA.

The SCA adopts common object request broker architecture (CORBA), which is the industry standard of a distributed object model, as middleware, and provides an integration environment of different types of software and hardware. The SCA is not a standard that is limited to a specific system, but is an independent system design framework. An SCA-based system means a communication system that is based on the SCA structure. For example, a software defined radio (SDR) system adopts the SCA as the standard of a software framework.

In the SCA, an application performs a function of one waveform. The application binds a plurality of components to construct one package, parses domain profiles that include information on the components, and installs, disposes, and drives them.

Meanwhile, in the SCA standard according to the related art, in order to parse the domain profiles, a parser in a form of a C++ class is generated and used whenever each of management components is needed. Accordingly, in order for the management components to obtain parsing information, the management components repetitively generate the same C++ class and repeat the same parsing process, which causes a problem in that a memory resource is wasted and system performance is deteriorated.

The above information disclosed in this Background section is only for enhancement of understanding of the background of the invention and therefore it may contain information that does not form the prior art that is already known in this country to a person of ordinary skill in the art.

### DISCLOSURE OF INVENTION

### Technical Problem

The present invention has been made in an effort to provide an efficient file parsing method and application generation method, and an SCA-based system having improved performance.

### Technical Solution

An exemplary embodiment of the present invention provides a file parsing method. The method includes driving a first component; registering the first component as a parsing device in a naming server; and when a second component requests parsing information, providing information that is obtained by parsing a file corresponding to the parsing information request by the first component to the second component.

Another exemplary embodiment of the present invention provides an application generation method that generates an application in a software communications architecture (SCA)-based system. The application generation method includes implementing a parser manager by a common object request broker architecture (CORBA) component; when receiving an application generation request, allowing the parser manager to parse at least one descriptor file corresponding to the application; and disposing at least one component corresponding to the application on the basis of information obtained by the parsing.

Still another exemplary embodiment of the present invention provides a recording medium that has a program, which is implemented in a software communications architecture (SCA)-based system, recorded therein. The program includes a function of implementing an integration parser function of parser functions related to application driving by one common object request broker architecture (CORBA) component; and a function of allowing the CORBA component to parse at least one file related to the application driving.

A further exemplary embodiment of the present invention provides a software communications architecture (SCA)-based system, which includes a file storage unit that stores at least one descriptor file to be parsed, and a parser manager that is implemented by a common object request broker architecture (CORBA) component and functions as an integration parser that parses the at least one descriptor file.

### Advantageous Effects

According to the embodiments of the present invention, the SCA-based system integrates parsers to parse descriptor files related to application driving into one integration parser, and generates a parser manager functioning as the integration parser by a CORBA component once. Therefore, it is possible to prevent wasting of a memory resource that occurs when repeatedly generating a parser in a form of a C++ class in the related art, thereby improving system performance.

### BRIEF DESCRIPTION OF THE DRAWINGS

FIG. 1 is a configuration diagram illustrating an SCA-based system according to an exemplary embodiment of the present invention.

FIG. 2 is a configuration diagram illustrating a domain profile that is defined in an SCA-based system according to an exemplary embodiment of the present invention.

FIG. 3 is a diagram illustrating a relationship between management components and parser managers according to an exemplary embodiment of the present invention.

FIG. 4 is a flowchart illustrating a core framework start procedure of an SCA-based system according to an exemplary embodiment of the present invention.

FIG. 5 is a flowchart illustrating an application generation method of an SCA-based system according to an exemplary embodiment of the present invention.

### MODE FOR THE INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

It will be understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The term “unit” used herein means one unit that processes a specific function or operation, and may be implemented by hardware or software, or a combination thereof.

Hereinafter, a software communications architecture (SCA)-based system, and a file parsing method and an application generation method thereof according to an exemplary embodiment of the present invention will be described in detail with reference to the accompanying drawings.

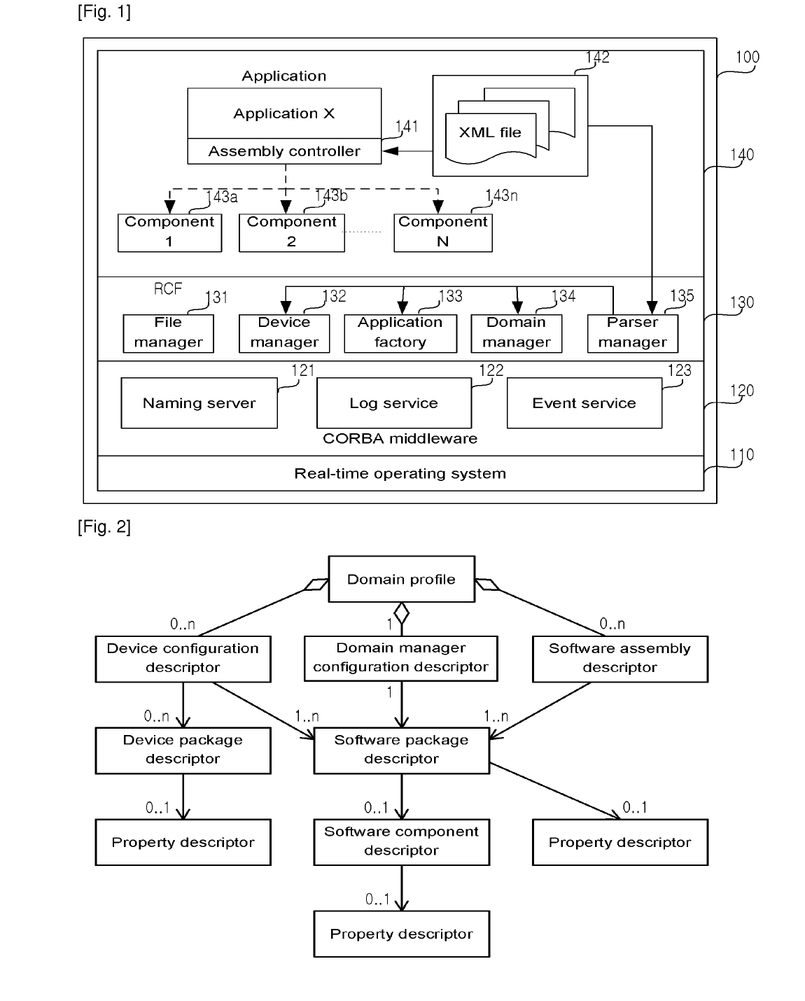

FIG. 1 is a configuration diagram illustrating an SCA-based system 100 according to an exemplary embodiment of the present invention.

Referring to FIG. 1, an SCA-based system 100 according to an exemplary embodiment of the present invention includes a real-time operating system 110 and common object request broker architecture (CORBA) middleware 120 that is defined by the SCA standard. The CORBA is an independent system design framework that provides an integration environment of different types of hardware and software.

The CORBA middleware 120 includes a naming server 121 and a plurality of services (log service and event service) 122 and 123 that process logs and events. The naming server 121 registers each component according to a registration request (bind) that is received from each component. When receiving a registration cancellation request from an operation-stopped component, the naming server 121 performs a function of canceling registration of the corresponding component.

A reconfigurable core framework (RCF) 130 based on the SCA is disposed on the real-time operating system 110 and the CORBA middleware 120. The reconfigurable core framework 130 includes a plurality of components. Specifically, the reconfigurable core framework 130 includes a file manager 131 that manages a file system, a device manager 132 that manages a plurality of logical devices obtained by functionally abstracting hardware devices, an application factory 133 that generates an application, and a domain manager 134 that performs device and application registration and cancellation. The reconfigurable core framework 130 applies system reconfiguration. The reconfigurable core framework 130 may further include a parser manager 135 in a form of a CORBA component that functions as a parser that parses application-related extensible markup language (XML) files and provides information generated through a parsing process to the management components. The parser manager 135 is initially generated once in the same manner as the other manager components 131 to 134. Accordingly, it is possible to prevent a memory resource from being repeatedly allocated due to repetitive parser generation caused by application driving and changing.

The SCA-based system 100 may include a plurality of applications, and each application 140 includes a plurality of components 143a to 143n and is constructed in a form of a package. At this time, the application factory 133 of the reconfigurable core framework 130 operates in connection with the domain manager 134. The application factory 133 uses an operator interface for controlling downloading, disposing, and driving of an application package in the SCA-based system 100 to construct software components as one application package. The application factory 133 disposes one application package in a driving device (executable device) and drives it.

An assembly controller 141 controls driving of the components 143a to 143n in the SCA-based system 100, and a file storage unit 142 stores XML files in which information of an application package, a component package, and components in the SCA-based system 100 is described.

Meanwhile, the SCA-based system 100 receives a driving command that a user inputs through a graphical user interface (GUI) (not shown).

FIG. 2 is a configuration diagram of a domain profile that is defined in an SCA-based system 100 according to an exemplary embodiment of the present invention.

Hardware devices and software components that constitute a domain of the SCA-based system 100 are described by XML files, that is, XML descriptor files, and a group of XML files is referred to as a domain profile.

Referring to FIG. 2, the domain profile includes 7 types of XML descriptor files. Specifically, the domain profile includes a device configuration descriptor (DCD) file, a domain manager configuration descriptor (DMD) file, a software assembly descriptor (SAD) file, a software package descriptor (SPD) file, a software component descriptor (SCD) file, a device package descriptor (DPD) file, and property descriptor (PRF) files. These files describe identifiers, capabilities, properties, and dependencies according to types of the components.

The DCD file includes information of devices that are coupled to a device manager, a method of searching a domain manager, configuration information for each device, and information on the parser manager 135, and has an extension of .dcd.xml. The DMD file includes configuration information for a domain manager and has an extension of .dmd.xml.

The SAD file includes information for components that constitute an application and has an extension of .sad.xml. The SPD file includes general information of a software package, such as a package name, a package developer, a property file, implementation code information, and dependencies between hardware and software, and has an extension of .spd.xml. The SCD file includes information on specific software components, such as a resource, a resource factory, and a device, and has an extension of .scd.xml.

The DPD file discriminates classes of devices and includes specific properties for the classes, and has an extension of .dpd.xml. The PRF file includes information for properties of components, such as configuration, test, driving, and allocation types, and has an extension of .prf.xml.

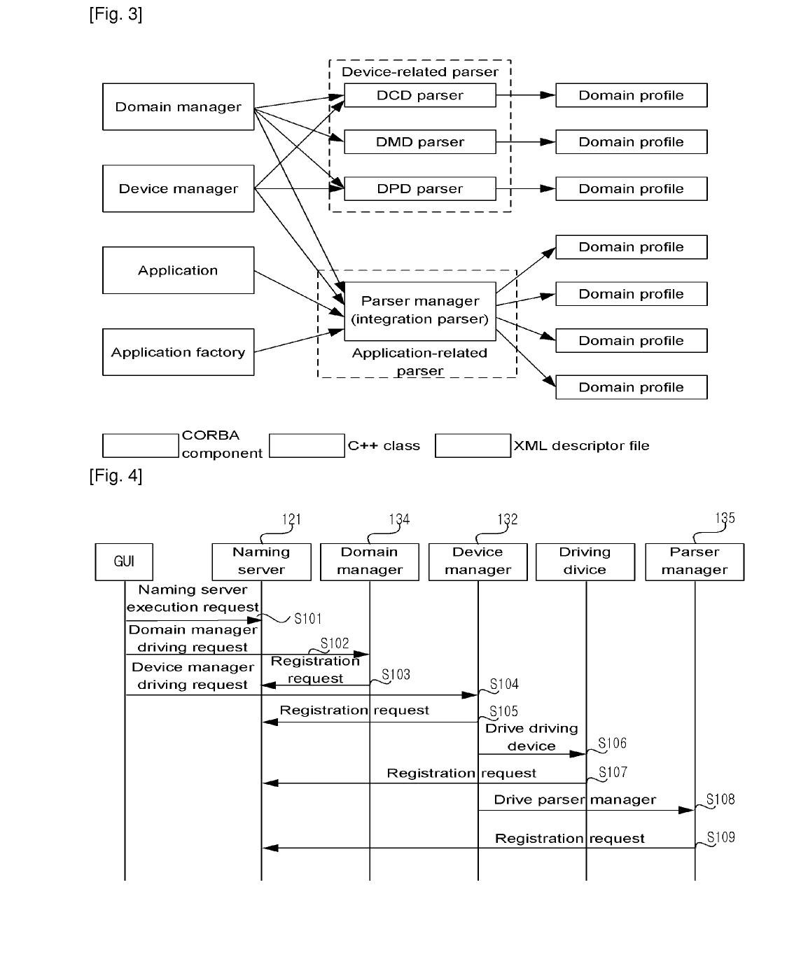

FIG. 3 shows a relationship between an application 140, management components 132 to 134 in a reconfigurable core framework 130, and a parser manager (XML parser) 135 as a file parsing device according to an exemplary embodiment of the present invention.

Meanwhile, among XML parsers that parse XML files, a DCD parser, a DMD parser, and a DPD parser are used to configure and drive the domain manger 134 and the device manager 132 functioning as management components in the domain of the SCA-based system 100, and devices or services, and are initially generated once to construct the reconfigurable core framework 130 of the SCA-based system 100. Accordingly, different from the other parsers that are related to disposing and driving of the application, the DCD parser, the DMD parser, and the DPD parser are not repetitively generated and used. Thus, in the exemplary embodiment of the present invention, as shown in FIG. 3, these parsers are implemented in a type of C++ class and used.

Meanwhile, since the application 140 uses a different application-related descriptor for each of waveforms that are applied to the SCA-based system 100, a file that needs to be parsed becomes different whenever a waveform is disposed. Accordingly, among the XML parsers, the SAD parser, the SPD parser, the SCD parser, and the PRF parser that are parsers related to the application are implemented to function as one integration parser by the parser manager 135, and the parser manager 135 is implemented by a CORBA component. Accordingly, the other manager components 131 to 134 request the parser manager 135 to parse the XML descriptor files related to installing and driving the application without generating a new parser. The parser manager 135 analyzes the SAD, SPD, and SCD files and provides the corresponding information to the manager components 131 to 134.

FIG. 4 is a flowchart illustrating a core framework start procedure of an SCA-based system 100 according to an exemplary embodiment of the present invention.

First, if a user requests to drive the naming server 121 through the GUI in order to use the CORBA components (execute naming server) (S101), the SCA-based system 100 drives the naming server 121.

Then, if the user requests to drive the domain manager 134 through the GUI (execute domain manager) (S102), the SCA-based system 100 drives the domain manager 134, and the domain manager 134 performs an initialization process and then performs a bind to request the naming server 121 to register the domain manager 134 (S103).

Further, if the user requests to drive the device manager 132 through the GUI (execute device manager) (S104), the SCA-based system 100 drives the device manager 132, and the device manager 132 performs an initialization process and then performs a bind to request the naming server 121 to register the device manager 132 (S105). Further, the device manager 132 generates the DCD parser, and parses information of the DCD file through the DCD parser. In addition, the device manager 132 confirms a driving device (executable device) from information that is obtained by parsing the DCD file, and drives the corresponding driving device (S106).

Therefore, the driving device performs an initialization process and performs a bind to request the naming server 121 to register the driving device (S107). Then, the device manager 132 drives the parser manager 135 on the basis of the information obtained by parsing the DCD file (S108). Therefore, the parser manager 135 performs an initialization process and then performs a bind to request the naming server 121 to register the parser manager 135 (S109).

As such, the parser manager 135 is implemented by a CORBA component and is registered in the naming server 121. Then, the parser manager 135 performs a function of an application-related integration parser, which is to be described hereinafter.

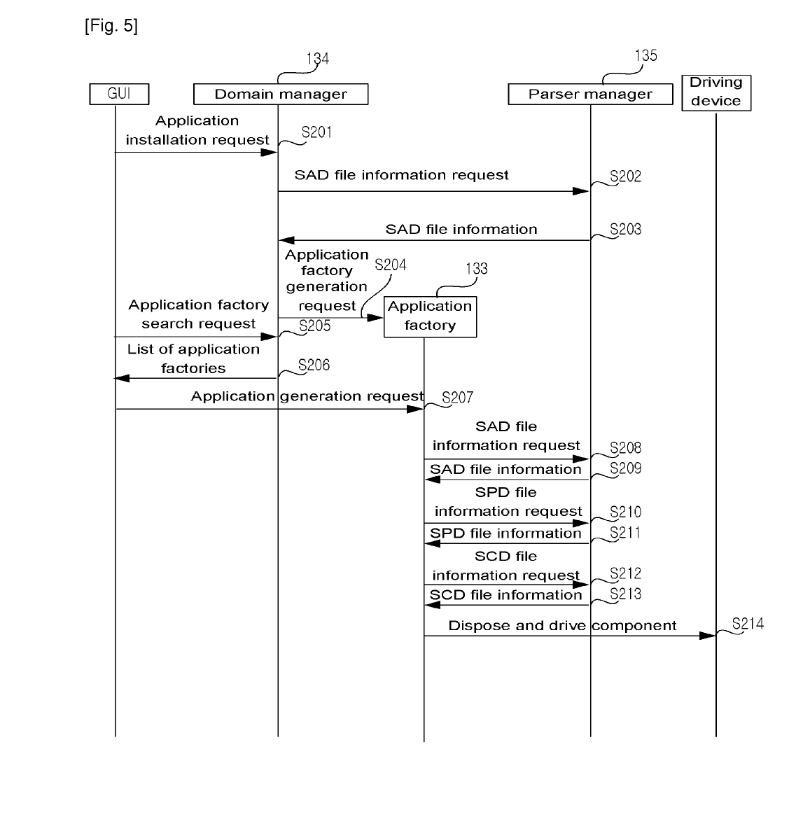

FIG. 5 is a flowchart illustrating a method of installing an application according to an exemplary embodiment of the present invention.

Referring to FIG. 5, if a user selects a SAD file app1_SAD.xml that corresponds to a specific application app1 that the user desires to generate through a GUI, information of the SAD file that is selected by the user is transmitted to the domain manager 134 (installApplication (app1_SAD.xml)) (S201). After receiving the information of the SAD file, the domain manager 134 requests the parser manager 135 to parse the corresponding SAD file (SAD_getInfo( )) (S202). The parser manager 135 performs an integration parser function and provides SAD file information obtained by parsing the corresponding SAD file to the domain manager 134 (S203). Therefore, the domain manager 134 generates the application factory 133 on the basis of the received SAD file information (new ApplicationFactory (app1_SAD.xml)) (S204).

Meanwhile, the user can request the domain manager 134 to send the information of the application factories 133 currently installed in the SCA-based system 100 through the GUI (getApplicationFactories) (S205). The domain manager can provide a list of all application factories that are currently installed in the SCA-based system 100 to the user (ApplicationFactoryList) (S206).

After confirming the list of application factories, the user selects the application factory 133 corresponding to the specific application app1 that the user desires to drive, from the provided list of application factories. The user requests the selected application factory 133 to install the corresponding application app1 (createApplicationInstance(app1)) (S207).

Therefore, the application factory 133 requests the parser manager 135 of the SAD file information to obtain information of components constituting the corresponding application (SAD_getInfo( )) (S208). The parser manager 135 performs an integration parser function to parse the corresponding SAD file and provides the SAD file information to the application factory 133 (S209).

After receiving the SAD file information, the application factory 133 confirms information of components that are to be driven, from the SAD file information, and requests the parser manager 135 to send the SPD file information corresponding to the components (SPD_getInfo( )) (S210). The parser manager 135 performs an integration parser function to parse the corresponding SPD files, and transmits the obtained SPD file information to the application factory 133 (S211).

Hereinafter, the application factory 133 confirms SCD files of components that need to be driven, from the SPD file information, and requests the parser manager 135 to send information of the corresponding SCD files (SCD_getInfo( )) (S212). The parser manager 135 parses the corresponding SCD files and provides SCD file information obtained by parsing the SCD files to the application factory 133 (S213). Accordingly, the application factory 133 obtains all information needed to generate components corresponding to an application that a user desires to drive.

The application factory 133 uses the obtained information to dispose all components needed when driving the application at the predetermined locations of the driving device (execute device) and drive all of the components (load and execute components) (S214).

As described above, according to the method in which application-related parsers are integrated into one parser and a corresponding integration parser function is implemented by one CORBA component in the SCA-based system 100, the integration parser is initially generated once as the CORBA component to reduce wasting of a memory resource occurring in the SCA-based system, and system performance can be improved, differently from the existing method in which each management component repeatedly generates a parser in a form of a C++ class whenever application-related descriptor file information is needed.

The exemplary embodiment of the present invention that has been described above may be implemented by not only an apparatus and a method but also a program capable of realizing a function corresponding to the structure according to the exemplary embodiment of the present invention and a recording medium having the program recorded therein. It can be understood by those skilled in the art that the implementation can be easily made from the above-described exemplary embodiment of the present invention.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A file parsing method comprising:
driving a first component;
registering the first component as a parsing device in a naming server; and
when a second component requests parsing information, providing information that is obtained by parsing a file corresponding to the parsing information request by the first component to the second component.

2. The file parsing method of claim 1, wherein the driving of the first component includes:
allowing a third component to parse a device configuration descriptor file; and
driving the first component on the basis of information obtained by parsing the device configuration descriptor file.

3. The file parsing method of claim 2, wherein the third component is a device manager in a reconfigurable core framework.

4. The file parsing method of claim 1, wherein the file parsing method is a file parsing method of a software communications architecture (SCA)-based system, and the first component is a common object request broker architecture (CORBA) component that is included in a reconfigurable core framework of the SCA-based system.

5. The file parsing method of claim 1, wherein the parsing information is information that is obtained by parsing a descriptor file that is related to application disposing and driving.

6. An application generation method that generates an application in a software communications architecture (SCA)-based system, the application generation method comprising:
implementing a parser manager by a common object request broker architecture (CORBA) component;
when receiving an application generation request, allowing the parser manager to parse at least one descriptor file corresponding to the application; and
disposing at least one component corresponding to the application on the basis of information obtained by the parsing.

7. The application generation method of claim 6, further comprising:
receiving a software assembly descriptor file that is used to install the application; and
generating an application factory on the basis of information obtained by parsing the software assembly descriptor file by the parser manager,
wherein the disposition is performed through the application factory.

8. The file parsing method of claim 6, wherein the descriptor file is one of a software assembly descriptor file, a software package descriptor file, and a software component descriptor file.

9. A recording medium that has a program, which is implemented in a software communications architecture (SCA)-based system, recorded therein, the program including:
a function of implementing an integration parser function of parser functions related to application driving by one common object request broker architecture (CORBA) component; and
a function of allowing the CORBA component to parse at least one file related to the application driving.

10. A software communications architecture (SCA)-based system comprising:
a file storage unit that stores at least one descriptor file to be parsed; and
a parser manager that is implemented by a common object request broker architecture (CORBA) component, and functions as an integration parser that parses the at least one descriptor file.

11. The SCA-based system of claim 10, further comprising
a device manager that drives the parser manager on the basis of information obtained by parsing a device configuration descriptor file.

12. The SCA-based system of claim 10, wherein the parser manager is included in a reconfigurable core framework in the SCA-based system.
